(19) United States
(12) Patent Application Publication
(10) Pub. No.: US 2025/0161896 A1
(43) Pub. Date: May 22, 2025

(54) EASY OPEN LID OF KITCHEN APPLIANCE

(71) Applicant: I-TECH USA, INC., Farmington Hills, MI (US)

(72) Inventor: Dominic Simenthi, Maradu (IN)

(21) Appl. No.: 18/950,732

(22) Filed: Nov. 18, 2024

Related U.S. Application Data
(60) Provisional application No. 63/600,107, filed on Nov. 17, 2023.

(51) Int. Cl. B01F 35/45; A47J 43/07; B01F 35/30; B01F 101/00; B65D 51/18; B65D 51/24; B65D 53/02

(52) U.S. Cl. CPC B01F 35/45; A47J 43/0716; B65D 51/18; B65D 51/242; B65D 53/02; B01F 2035/351; B01F 2101/1805; B65D 2251/0012; B65D 2251/0081

(57) ABSTRACT

The present disclosure provides a lid for a container. The lid can include a handle, a handle body, a lid body, a gasket support, and a gasket. The handle can be movable between a raised position and a lowered position. The lid body can include a top portion and a bottom portion. The bottom portion can have a coupling section and a frustoconical section. The gasket support can be disposed between the top portion and the bottom portion. The gasket support can be movable along the frustoconical section between an expanded position and a contracted position by a movement of the handle. The gasket can include an interior surface circumscribing and abutting the gasket support. The gasket can be elastically deformable between a sealed position and an unsealed position by a movement of the gasket support.

### CROSS-REFERENCE TO RELATED APPLICATIONS

This application claims the benefit of U.S. Provisional Application No. 63/600, 107, filed on Nov. 17, 2023. The entire disclosure of the above application is incorporated herein by reference.

### FIELD

The present technology relates to a lid for a kitchen appliance, and more particularly, a lid for a blender.

### INTRODUCTION

This section provides background information related to the present disclosure which is not necessarily prior art.

Blender lids are an important component of any blender, serving multiple functions such as militates against splatters, containing ingredients during blending, and ensuring clean operation. The way a blender lid attaches to a blender varies depending on the blender's design, but there are several common mechanisms used in the industry.

One of the most prevalent methods for lid attachment is a twist-on design, where the blender lid typically features a circular lip or collar that matches the shape and size of the opening of the jar. A user places the lid on top of the body and then twists it clockwise to secure it in place. This twisting action engages cooperating threads or grooves on both the lid and the body, creating a secure gasket. Although twist-on lids are very common, they can be difficult to remove once juicing has occurred due to build-up of pressure within the jar.

Another common lid attachment method is a snap-on lid that may use tabs or clips along an edge that align with corresponding notches or slots on a rim of the jar. A user may position the lid over the body and press down firmly until the tabs or clips snap into place. This mechanism is quick and convenient, ensuring a tight fit. However, due to the protrusions required for a snap fit lid, the protrusions can easily become broken during cleaning and storage, and once broken, the snap fit lid may be rendered useless.

Yet another type of lid attachment for blenders is a magnetic lid. The magnetic lid is commonly used with high-end blenders and may feature magnets embedded within the lid and the jar. When the lid is placed on the body, the magnets cooperate to create a strong and secure connection, ensuring that the lid stays in place during juicing. However, magnetic lids can be expensive and require an additional step in manufacturing.

Accordingly, there is a continuing need for a lid for a blender that is easy to use, durable, and cost efficient to manufacture.

### SUMMARY

In concordance with the instant disclosure, a lid for a blender that is easy to use, durable, and cost efficient to manufacture, has surprisingly been discovered.

The present technology includes articles of manufacture, systems, and processes that relate to sealing a container with a lid.

In one embodiment, a lid for a container includes a handle, a handle body, a lid body, a gasket support, and a gasket. The handle can be hingedly coupled to the handle body. The handle can be movable between a raised position and a lowered position. The lid body can include a top portion and a bottom portion. The top portion can be secured between the handle body and the bottom portion of the lid body. The bottom portion of the lid body can have a coupling section and a frustoconical section. The handle body can be coupled to the coupling section of the bottom portion of the lid body. The bottom portion can be movable between a resting position and a lifted position, The gasket support can be disposed between the top portion and the bottom portion of the lid body. The gasket support can be disposed adjacent the frustoconical section of the bottom portion. The gasket support can be movable along the frustoconical section between an expanded position and a contracted position by a movement of the handle. The gasket can include an interior surface circumscribing and abutting the gasket support. The gasket can be disposed adjacent the top portion and the bottom portion of the lid body. The gasket can be elastically deformable between a sealed position and an unsealed position by a movement of the gasket support. The gasket in the sealed position is sealingly engaged with the container, and the gasket in the unsealed position is disengaged from the container.

In another embodiment, a container assembly includes a container and the lid as described herein, which can be shaped to fit on the container.

In a further embodiment, a method for holding content can include a step of providing a container and placing the contents into the container. The method can include providing a lid as described herein and placing the lid onto the container. The handle can be moved from the raised position to the lowered position, whereby the gasket support is caused to move from the contracted position to the expanded position, and the gasket is caused to deform from the unsealed position to the sealed position to form a fluid-tight seal between the lid and the container, to thereby seal the contents within the container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a front, top perspective view of a lid in a container;

FIG. 2 is a rear, top perspective view of the lid and the container, shown in FIG. 1;

FIG. 3 is a top plan view of the lid;

FIG. 4 is a bottom plan view of the lid, shown in FIG. 3;

FIG. 5 is a front elevational view of the lid, shown in FIG. 3;

FIG. 6 is a rear elevational view of the lid, shown in FIG. 3;

FIG. 7 is a right-side elevational view of the lid, shown in FIG. 3;

FIG. 8 is a left-side elevational view of the lid, shown in FIG. 3;

FIG. 9 is a front elevational exploded view of the lid including a handle, a plug, a top portion of a lid body, a gasket support, a gasket, and a bottom portion of the lid body;

FIG. 10 is a top perspective exploded view of the lid including a handle, a plug, a top portion of a lid body, a gasket support, a gasket, and a bottom portion of the lid body, shown in FIG. 9;

FIG. 11 is a cross-sectional view of the lid with the handle in a raised position, the gasket support in a contracted position, and the gasket in an unsealed position, taken at a section line A-A of FIG. 3;

FIG. 12 is a cross-sectional view of the lid showing movement of the handle between the raised position and the lowered position, the gasket support between the contracted position and the expanded position, and the gasket between the unsealed position and the sealed position, taken at a section line B-B of FIG. 3;

FIG. 13 a cross-sectional view of the lid with the handle in a lowered position, the gasket support in an expanded position, and the gasket in a sealed position, taken at a section line C-C of FIG. 4; and

FIG. 14 is a flowchart depicting a method of sealing a container with a lid according to various embodiments of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

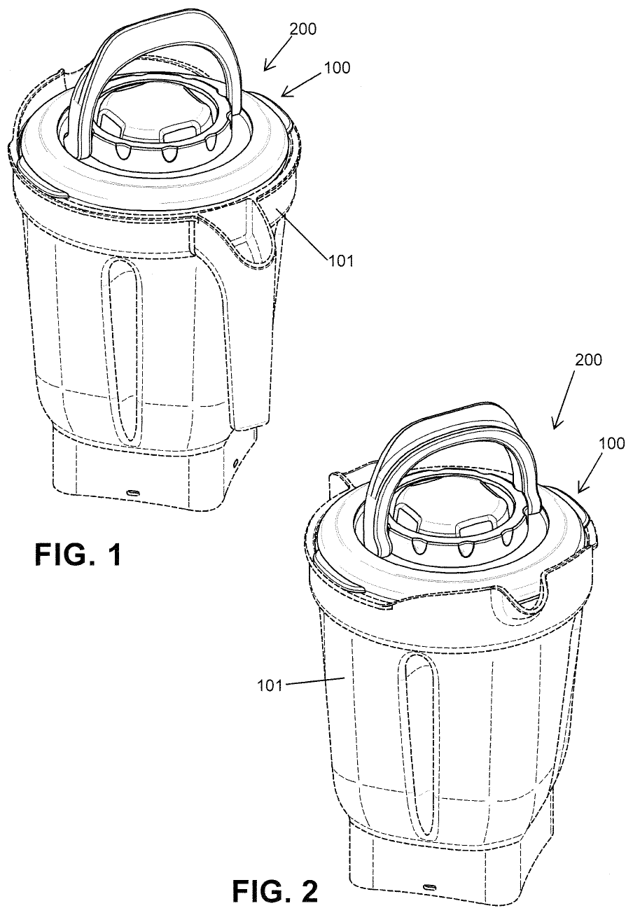

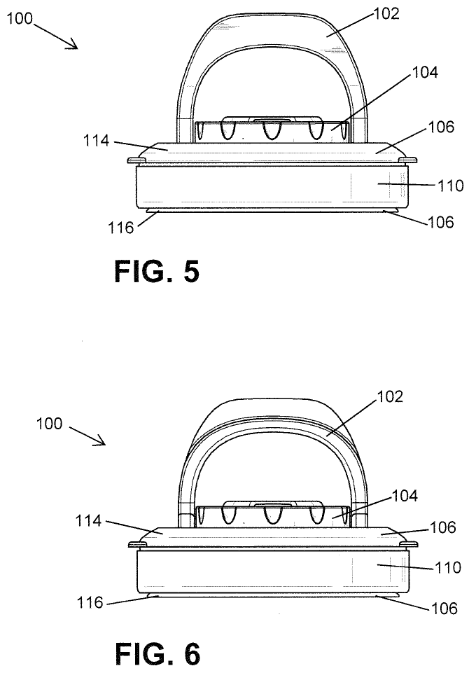

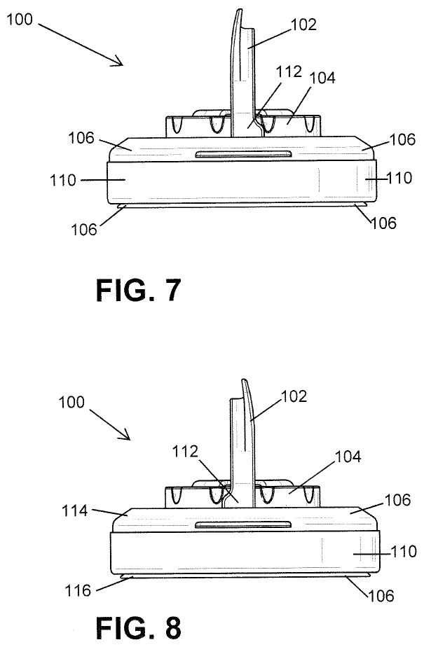

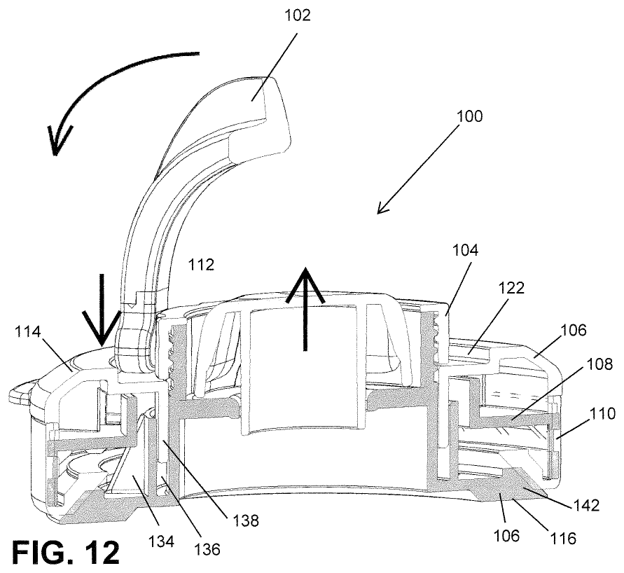

The present disclosure provides a lid 100 for a container 101. The lid 100 can include a handle 102, a handle body 104, a lid body 106, a gasket support 108, and a gasket 110, shown generally in FIGS. 1-13. Advantageously, the lid 100 allows a user to easily and quickly seal the container 101 and alternatively to release the seal to open the container 101.

The accompanying figures show an embodiment of the lid 100 where the lid 100 and the container 101 have a particular size and shape. It should be appreciated however, that the lid 100 can have any suitable size and/or shape to accommodate a size and/or shape of the container 101. The container 101 can be any kitchen or household container for use as storage or to process an object. For example, the container 101 can be coupled or attached to a kitchen appliance for use such as a food processor or a blender, as shown in exemplary FIGS. 1-2. A skilled artisan can select a suitable container 101 within the scope of the present disclosure.

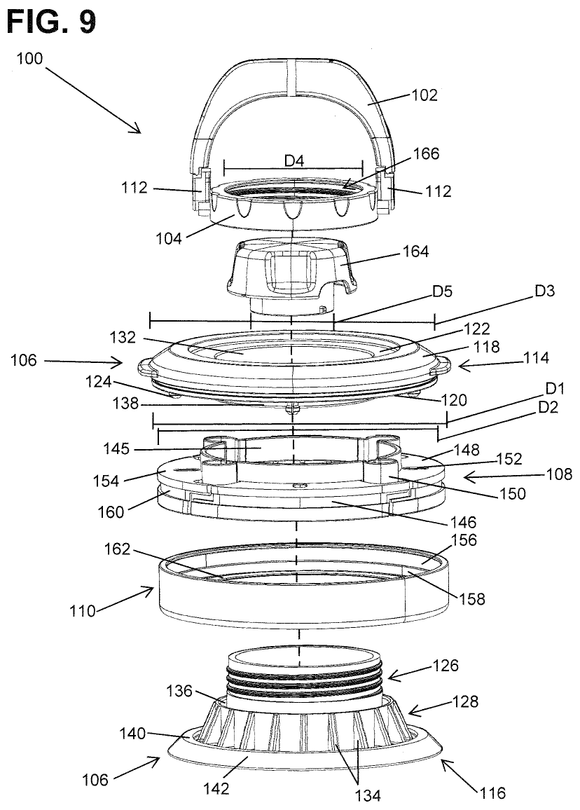

As shown in FIGS. 1-2, the handle 102 and handle body 104 form an integrated mechanism that enables the sealing functionality of the lid 100. The handle 102 can be hingedly attached to the handle body 104, allowing for smooth movement between a raised position and a lowered position. The handle body 104 can be centrally positioned adjacent the lid body 106. With reference to FIG. 9, the handle 102 can include a cam 112 disposed at each terminus of the handle 102. Each cam 112 can be bulbous in shape to allow for movement of the handle 102 and therefore, pivoting of the cam 112 to place a force on a top portion 114 and force movement of the handle body 104 and by extension, a bottom portion 116 of the lid body 106, upward, as described hereinbelow.

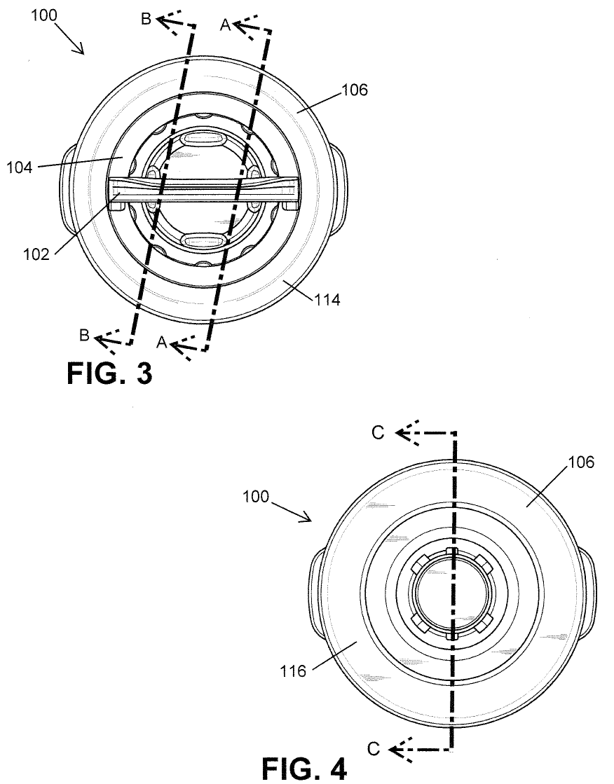

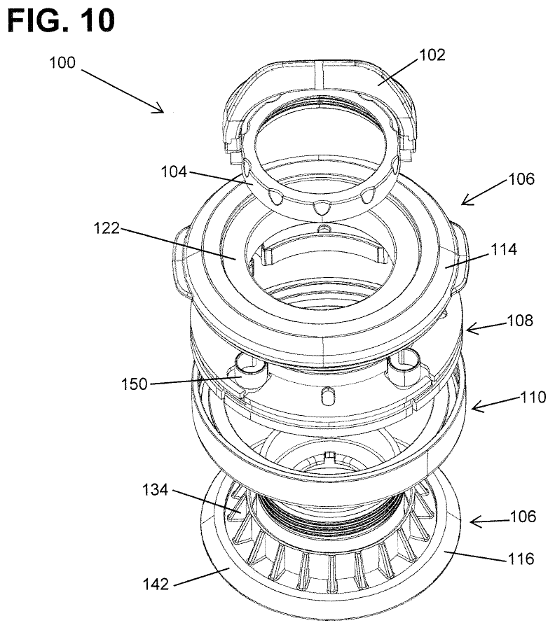

With reference to FIG. 10, the lid body 106 can include the top portion 114 and the bottom portion 116. The top portion 114 can be secured between the handle body 104 and the bottom portion 116 of the lid body 106. For example, and as shown in FIG. 3, the top portion 114 can have a circular cross section configured for use with a container 101 having a circular cross section. A skilled artisan can select a suitable cross-sectional shape for the top portion 114 within the scope of the present disclosure.

With reference to FIG. 9, the top portion 114 of the lid body 106 can include a top side 118 and a bottom side 120. The top side 118 can include an annular depression 122 that receives the handle 102 and the cam 112 when the handle 102 is moved to the lowered position. It should be appreciated that the annular depression 122 allows each cam 112 of the handle 102 to apply a force on the top portion 114 of the lid body 106 thereby resulting in movement of the bottom portion 116 of the lid body 106, the gasket support 108, and the gasket 110, as described hereinbelow. The top portion 114 can further include a post 124 disposed on the bottom side 120 of the top portion 114 of the lid body 106. The post 124 can be used to couple the top portion 114 of the lid body 106 to the gasket support 108.

With continued reference to FIG. 9, the bottom portion 116 of the lid body 106 can move between a resting position and a lifted position. The bottom portion 116 can include a coupling section 126 and a frustoconical section 128. The handle body 104 can be coupled to the coupling section 126 of the bottom portion 116 of the lid body 106. For example, the coupling section 1124 can be threaded to allow for the handle body 104 to be threadably coupled with the bottom portion 116 of the lid body 106. It should be appreciated that a skilled artisan can select any coupling means for the coupling section 126 within the scope of the present disclosure. It should be appreciated that the top portion 114 of the lid body 106 can include a first aperture 132 through which the handle body 104 can couple to the coupling section 126. The threaded coupling of the coupling section 126 of bottom portion 116 of the lid body 106 and the handle body 104 can facilitate movement of the gasket support 108 and gasket 110 where the handle 102 is in the lowered position and the cam 112 is applying a force on the top portion 114 of the lid body 106, specifically the annular depression 122.

It should be appreciated that the resting position of the bottom portion 116 can correspond substantially with the raised position of the handle 102 and the lifted position of the bottom portion can correspond substantially with the lowered position of the handle 102. Where the handle 102 is in the lowered position, the cam 112 of the handle 102 can apply a force on the top portion 114 of the lid body 106 thereby moving the handle body 104 and the bottom portion 116 of the lid body 106 upward from the resting position to the lifted position.

As shown in FIGS. 9-10, the frustoconical section 128 can be defined by a plurality of sloped ribs 134 arranged around the bottom portion 116 of the lid body 106. The sloped ribs 134 can abut the gasket support 108. The sloped ribs 134 can facilitate the lateral movement of both the gasket support 108 and gasket 110 on the bottom portion 116 of the lid body 106. Where the handle 102 is in the raised position, the gasket support 108 remains either free from contact or unexpanded by the contact with the sloped ribs, but where the handle 102 is moved to the lowered position the sloped ribs 134 serve as guide surfaces that direct the outward expansion of the gasket support 108, and in turn thereby deform the gasket 110.

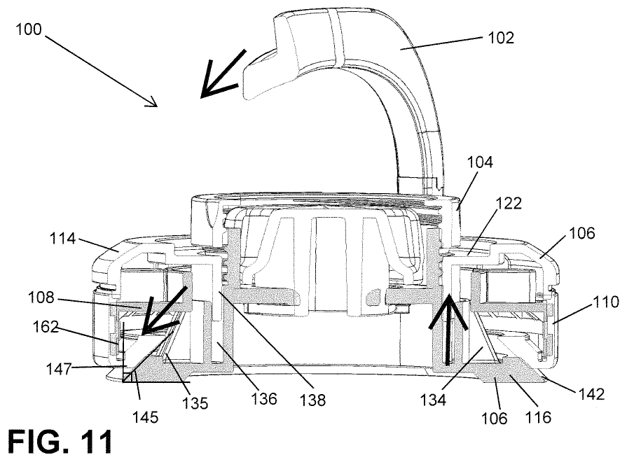

It should be appreciated that each of the sloped ribs 134 can maintain direct contact with the gasket support 108 during the transition of the handle 102 between the raised position and the lowered position, and where the handle 102 is in the lowered position. Additionally, an angled orientation of the sloped ribs 134 allows for the transformation of the vertical movement of the handle 102 and bottom portion 116 of the lid body 106, as described hereinbelow, into the lateral force needed for movement of the gasket support 108 and the gasket 110. The sloped ribs 134 can have a surface 135 with an angled orientation relative to a horizontal plane on which the bottom portion 116 of the lid body 106 is disposed, as shown in FIG. 11. In one embodiment, the surface 135 can have an angle ranging between about 45° and about 85°. In a more particular embodiment, the surface 135 can have an angle ranging between about 55° and about 75°. In a most particular embodiment, the surface 135 can have an angle of about 65°. A skilled artisan can select a suitable angle for the surface within the scope of the present disclosure.

The sloped ribs 134 can be arranged in a plurality formed around the bottom portion 116 of the lid body 106. For example, the sloped ribs 134 can be disposed equidistantly around the bottom portion 116 of the lid body 106 in the shape having a substantially circular cross section, as shown in FIG. 10. The sloped ribs 134 can evenly distribute the force applied by the movement of the handle 102 to allow for uniform movement of the gasket support 108 and gasket 110 during operation. A skilled artisan can select a suitable number of sloped ribs 134 within the scope of the present disclosure.

In a further embodiment, not shown, it should be understood that the frustoconical section can be provided without the sloped ribs 134, for example, by forming the bottom portion 116 of the lid body 106 in a manner to provide the frustoconical shape. One or ordinary skill in the art can also select other suitable means and configurations of the bottom portion 116 to provide the frustoconical section suitable for slidable movement of the gasket support 108, as desired.

In yet another embodiment, it should be appreciated that the bottom portion 116 can have an annular channel 136 disposed between the coupling section 126 and the frustoconical section 128, as shown in FIG. 9. The top portion 114 of the lid body 106 can have an annular projection 138 that is received by the annular channel 136 of the bottom portion 116 of the lid body 106. In this way, the top portion 114 of the lid body 106 and the bottom portion 116 of the lid body 106 can be coupled via a friction fit and, along with the gasket 110, enclose the gasket support 108. It should be appreciated that as the handle body 104 is moved upward by the movement of the handle 102 into the lowered position, the bottom portion 116 of the lid body 106 is also moved upward and the annular projection 138 of the top portion 114 of the lid body 106 can move further into the annular channel 136 of the bottom portion 116 of the lid body 106.

As shown in FIG. 9, the bottom portion 116 can include a lip 140 disposed adjacent to the frustoconical section 128. The lip 140 can have a beveled surface 142 oriented at a first angle 145 relative to the horizontal plane the bottom portion 116 of the lid body 106 is disposed on, as shown in FIG. 11. As described hereinbelow, the first angle 145 can correspond with the gasket 110. The first angle 145 can facilitate a smooth transition of the gasket 110 during operation. In one embodiment, the first angle 145 can be between about 25° and about 65°. In a more particular embodiment, the first angle 145 can be between about 35° and about 55°. In a most particular embodiment, the first angle 145 can be about 45°. A skilled artisan can select a suitable first angle 145 within the scope of the present disclosure.

With renewed reference to FIG. 9, the gasket support 108 can function as a spring under pressure within the lid 100. The gasket support 108 can be disposed between the top portion 114 of the lid body 106 and the bottom portion 116 of the lid body 106 and have a gasket aperture centrally disposed therethrough. The gasket support 108 can be disposed adjacent to the frustoconical section 128 of the bottom portion 116 of the lid body 106. An inner surface 143 of the gasket support 108 can be movable along the frustoconical section 128 between an expanded position and a contracted position by a movement of the handle 102 and the bottom portion 116 of the lid body 106.

It should be appreciated that the contracted position of the gasket support 108 can correspond substantially with the raised position of the handle 102 and the expanded position of the gasket support 108 can correspond substantially with the lowered position of the handle 102. Where the handle 102 is in the lowered position, the cam 112 of the handle 102 can apply a force on the top portion 114 of the lid body 106 thereby moving the handle body 104 and the bottom portion 116 of the lid body 106 upward from the resting position to the lifted position. As the upward force on the bottom portion 116 causes the bottom portion 116 to rise, the bottom portion 116 can contact the inner surface 143 of the gasket support 108 and the continued upward movement of the bottom portion 116 can push the gasket support 108 outward in all directions along the sloped ribs 134, resulting in the gasket support 108 expanding from a first diameter (D1) in the contracted position to a second diameter (D2) in the expanded position. In this way, the first diameter (D1) can be less than the second diameter (D2).

With reference to FIG. 9, it should be appreciated that an interior surface 144 of the top portion 114 of the lid body 106 can have a third diameter (D3). The second diameter (D2) of the gasket support 108 in the expanded position can be less than the third diameter (D3) of the top portion 114 of the lid body 106 such that the gasket support 108 at its greatest diameter does not extend beyond a perimeter of the lid body 106. A skilled artisan can select a suitable first diameter (D1) and second diameter (D2) for the gasket support 108 and third diameter (D3) of the top portion 114 of the lid body 106 within the scope of the present disclosure.

The gasket support 108 can include a first brace 146 and a second brace 148. In certain embodiments, as shown in FIG. 9, the gasket support 108 can include at least four braces. The first brace 146 can be coupled to the second brace 148 via a spring element 150. The spring clement 150 can allow the gasket support 108 to act as a spring under pressure by the handle 102 in the lowered position, while maintaining the ability to return to an initial shape of the gasket support 108 when not under load by the handle 102. The spring element 150 can have an arched element that connects the first brace 146 to the second brace 148, with the first brace 146 and the second brace 148 otherwise being unconnected.

The use of the spring clement 150 relies on the material composition and structural properties of the spring element 150. The gasket support 108, including the spring element 150, can be formed from a thermoplastic material that provides the necessary flexibility and resilience, for example. Suitable materials can include engineering plastics with good elastic properties and fatigue resistance, such as polyoxymethylene (POM) or modified polyamide, for example, which can maintain their spring characteristics over repeated compression and expansion cycles. A skilled artisan can select other suitable materials for the gasket support 108 and spring mechanism 150 within the scope of the present disclosure.

Multiple spring elements 150 can be incorporated into the structure of the gasket support 108, with each spring clement 150 coupling separate braces. The spring elements 150 can be positioned equidistantly around a circumference of the gasket support 108 to promote uniform expansion and contraction in operation. The balanced arrangement of spring elements 150 can maintain consistent pressure distribution during the scaling process and ensures smooth, even movement between the expanded position and the contracted position. The equidistant positioning of spring elements 150 also helps maintain structural stability while allowing for the necessary flexibility that allows the gasket support 108 to expand outward when the handle 102 is operated.

As described hereinabove, the top portion 114 of the lid body 106 can have the post 124 disposed on the bottom side 120 of the top portion 114. The gasket support 108 can have an opening 152 disposed on an upper surface 154 of the gasket support 108 and opening 152 can be disposed through the gasket support 108. The post 124 of the top portion 114 of the lid body 106 can be disposed through the opening 152 of the gasket support 108 to couple the lid body 106 to the gasket support 108. Specifically, the post 124 can have a ball disposed on a terminal end of the post 124, which allows for the post to be retained within the opening 152 while permitting movement. Advantageously, the opening 152 can have an oblong shape, as shown in FIG. 9, to allow for the gasket support 108 to move outward and along the frustoconical section 128 of the bottom portion 116 of the lid body 106 where the force from the cam 112 of the handle 102 is applied to the top portion 114 of the lid body 106. The oblong shape of the opening 152 can allow for the lateral movement of the gasket support 108 and the top portion 114 of the lid body 106 to be coupled without the top portion 114 limiting the movement of the gasket support 108 between the expanded position and the contracted position corresponding with the movement of the handle 102 between the raised position and the lowered position. As an example, the oblong shape of the opening 152 permits for the movement while another shaped opening, such as a circular opening, would prevent the lateral movement and stop the gasket support 108 from properly expanding. When force from the cam 112 of the handle 102 can be applied to the top portion 114 of the lid body 106, the oblong opening 152 can allow the gasket support 108 to expand outward while remaining coupled to the post 124, enabling the gasket support 108 to move from the first diameter (D1) in the contracted position to the second diameter (D2) in the expanded position. The oblong shape of the opening 152 can militate against the top portion 114 of the lid body 106 from limiting the movement of the gasket support 108 between the expanded and contracted positions that can correspond with the handle 102 movement.

As shown in FIG. 9, the gasket 110 can be disposed adjacent the top portion 114 of the lid body 106 and the bottom portion 116 of the lid body 106 and can have an interior surface 156 circumscribing the lid 100. The gasket 110 can abut the gasket support 108. The gasket 110 can be elastically deformable between a sealed position and an unsealed position by a movement of the gasket support 108. It should be appreciated that the unsealed position of the gasket 110 can correspond with the contracted position of the gasket support 108 and the raised position of the handle 102. Conversely, the sealed position of the gasket 110 can correspond with the expanded position of the gasket support 108 and the lowered position of the handle 102.

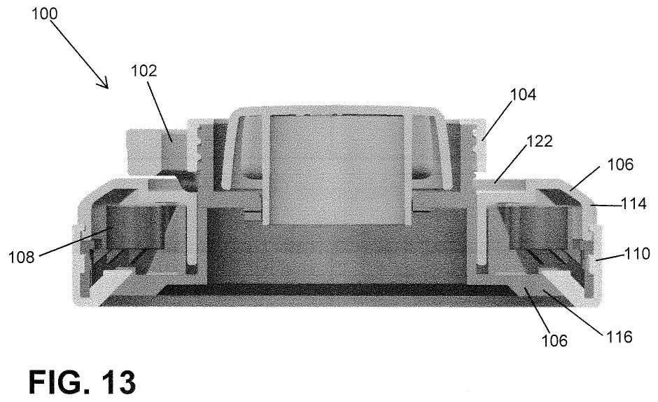

In operation, where the handle 102 is mechanically moved from the raised position, as shown in FIG. 11, to the lowered position as shown in FIG. 13, the cam 112 of the handle 102 can apply a force on the top portion 114 of the lid body 106 thereby moving the handle body 104 and the bottom portion 116 of the lid body 106 upward. The upward force on the bottom portion 116 causes the bottom portion 116 to rise from the resting position to the lifted position. The bottom portion 116 can contact the inner surface 143 of the gasket support 108 and the continued upward movement of the bottom portion 116 can push the gasket support 108 outward in all directions along the sloped ribs 134, resulting in the gasket support 108 moving from the contracted position to the expanded position. As the gasket support 108 moves to the expanded position, the gasket 110 can expand along with the gasket support 108 from the unsealed position to the sealed position until the gasket 110 is in the sealed position and makes contact with the container 101, achieving a secure seal.

In operation, where the handle 102 is mechanically moved from the lowered position as shown in FIG. 13, to the raised position as shown in FIG. 11, the cam 112 of the handle 102 can release the force on the top portion 114 of the lid body 106. The release of the mechanical force can allow the spring element 150 of the gasket support 108 to move from the expanded position to the contract position. The movement of the spring element 150 can propel the gasket support 108 upward along the sloped ribs 134, releasing the outward force on the gasket 110. As this force is released, the gasket 110 can move from the sealed position to the unsealed position, disengaging from the container 101. The upward force generated by the contraction of the gasket support 108 can also help move the top portion 114 of the lid body 106 upward, completing the unsealing process.

The gasket support 108 and the gasket 110 can be coupled to allow for the movement of the gasket support 108 to cause elastic expansion of the gasket 110 to the sealed position. For this purpose, the gasket 110 can include an annular protrusion 158 and the gasket support can include an annular recess 160. The annular recess 160 of the gasket support 108 can receive the annular protrusion 158 of the gasket 110. Advantageously, the annular protrusion 158 and annular recess 160 can allow for the gasket support 108 and the gasket 110 to remain coupled when moving between the expanded and sealed positions and the contracted and unsealed positions. A skilled artisan can select another suitable coupling means for the gasket support 108 and the gasket 110 within the scope of the present disclosure.

As shown in FIG. 10, the gasket 110 can include a sloped surface 162 that is oriented at a second angle 147 relative to the horizontal plane the bottom portion 116 of the lid body 106 is disposed on. The first angle 145 of the beveled surface 142 of the bottom portion 116 of the lid body 106 and the second angle 147 of the sloped surface 162 of the gasket 110 can be complementary angles. Advantageously, this can allow the gasket 110 to move down the bottom portion 116 of the lid body 106 where the gasket 110 expands from the unsealed position to the sealed position while remaining in contact with the bottom portion 116. Conversely, this can allow the gasket 110 to move up the bottom portion 116 of the lid body 106 where the gasket 110 contracts from the sealed position to the unsealed position while remaining in contact with the bottom portion 116. Where the first angle 145 and the second angle 147 are complementary angles, the gasket 110 can smoothly transition between the sealed position and the unsealed position without catching on the bottom portion 116. A skilled artisan can select a suitable first angle 145 and second angle 147 within the scope of the present disclosure.

With reference to FIG. 9, the lid 100 can further include a plug 164. The plug 164 can be removably disposed adjacent a second aperture 166 in the handle body 104. The second aperture 166 can be selectively closed or opened by the plug 164. The second aperture 166 can have a fourth diameter (D4) and the plug 164 can a fifth diameter (D5). The fourth diameter (D4) of the second aperture 166 can be substantially the same as the fifth diameter (D5) of the plug 164. In this way, the plug 164 can be securely held by friction fit with the handle body 104 when the plug 164 is removable imposed in the second aperture 166.

Advantageoulsy, the lid 100 of the present disclosure provides a handle-activated sealing mechanism that can operate through simple vertical movements, utilizing a gasket support 108 with integrated spring elements 150. The sloped ribs 134 can transform vertical handle movement into lateral sealing force, working with corresponding beveled surfaces to facilitate smooth gasket movement, while the frustoconical section design ensures consistent gasket expansion.

The present disclosure provides a container assembly 200, as shown in FIGS. 1-2. The container assembly can include a container 101 and the lid 100 as described herein. The lid 100 can be used with any kitchen or household container 101 for storage or processing objects. Where the lid 100 is placed on the container 101 and the handle 102 is moved to the lowered position, the gasket support 108 expands outward along the sloped ribs 134, causing the gasket 110 to move into the sealed position where it makes complete contact with an inner wall of the container 101. Desirably, the sealing mechanism creates an effective liquid-proof and air-tight seal that can militate against contents such as food or liquid from splashing out of the container 101 during use, while also militating against anything entering or exiting the container during operation or use.

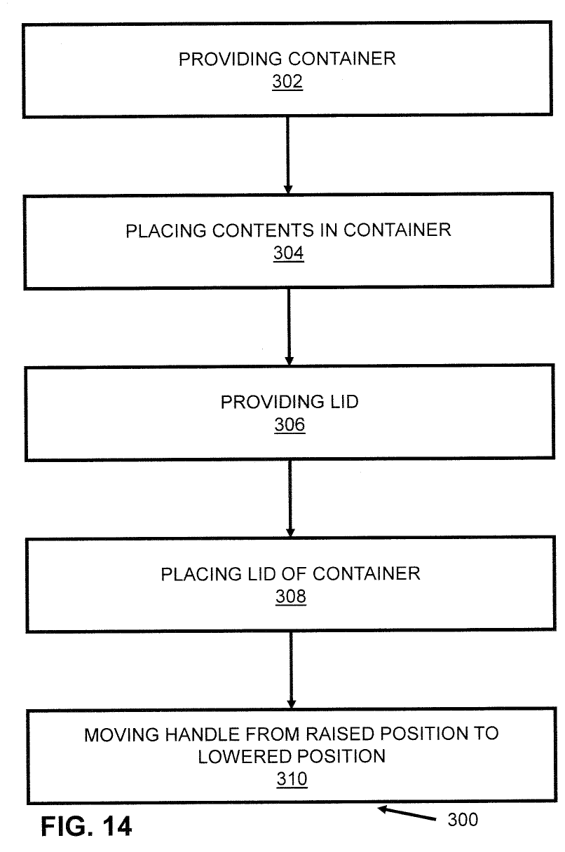

The present disclosure provides a method 300 for holding contents, shown generally in FIG. 14. The method 300 can include a first step 302 of providing the container 101 and a second step 304 of placing the contents into the container 101. The method can include a third step of providing the lid 100, as described herein. In a fourth step 308, the method 300 can include placing the lid 100 onto the container 101. The handle 102 can be moved from the raised position to the lowered position whereby bottom portion 116 of the lid body 106 is caused to move from the resting position and the lifted position, the gasket support 108 is moved from the contracted position to the expanded position and the gasket 110 is moved from the unsealed position to the sealed position in a step 308. By moving the handle 102 to the lowered position and causing movement of the gasket support 108 and the gasket 110, the lid 100 can be sealed within the container 101.

Advantageously, the handle-activated system can enable vertical movement for scaling and unsealing, militating against the challenges associated with twist-on lids that can be difficult to remove due to pressure buildup or snap-on lids with breakable components. The spring element 150 and sloped ribs 134, work together to create uniform pressure distribution and consistent sealing performance, while the corresponding beveled or sloped surfaces 142, 162 provide smooth gasket movement. Desirably, the lid 100 creates an effective liquid-proof and air-tight seal that militates against spills during operation while maintaining the freshness of stored contents, making the lid 100 particularly effective for blending applications where pressure management and content preservation are necessary.

### EXAMPLES

Example embodiments of the present technology are provided with reference to the several figures enclosed herewith.

In a first example, a user can place contents such as food items into any suitable kitchen or household container 101 designed for storage. The lid 100 can be positioned on the container 101 with the handle 102 in the raised position, which maintains the gasket 110 in an unsealed position and allows for easy placement. The container 101 can be selected based on the specific storage needs and the size and shape of the lid 100.

To seal the container 101 with the lid 100, the user can push down on the handle 102, initiating the sealing mechanism. As the handle 102 moves to the lowered position, the cam 112 engages with the top portion 114 of the lid body 106, causing the gasket support 108 to expand outward along the sloped ribs 134. The expansion pushes the gasket 110 into sealing contact with the container 101, creating an air-tight and liquid-proof seal that helps preserve the freshness of the stored food.

The sealed container 101 with food can then be stored without concern for leakage or spoilage, as the gasket 110 maintains consistent pressure against the container walls through the spring element 150 in the gasket support 108. The components of the lid 100 work together to maintain uniform pressure distribution around the container 101 rim, ensuring the food remains securely contained and fresh. The lid 100 effectively militates against anything entering or exiting the container during storage.

When the user needs to access the stored food, they can simply pull up on the handle 102 to release the seal. This upward movement allows the spring element 150 to mechanically move the gasket support 108 from the expanded position back to the contracted position, smoothly disengaging the gasket 110 from the wall of the container 101. The lid 100 can then be removed from the container 101 without the difficulty often associated with traditional storage container lids, allowing quick access to the stored food.

In a second example, a user can place the lid 100 onto a blender jar before processing food items. The lid 100 can be initially positioned with the handle 102 in the raised position, which maintains the gasket 110 in an unsealed position and allows for easy placement of the lid 100 onto the jar.

To seal the blender jar, the user can push down on the handle 102 to initiate the sealing mechanism. As the handle 102 moves to the lowered position, the cam 112 engages with the top portion 114 of the lid body 106, causing the gasket support 108 to expand outward along the sloped ribs 134. The expansion pushes the gasket 110 into sealing contact with the jar walls, creating an air-tight and liquid-proof seal that helps militate against splatters and contain ingredients during blending. The sealed lid 100 can effectively maintain pressure within the jar during blending operations, as the gasket 110 maintains consistent pressure against the jar walls through the spring element 150 in the gasket support 108. The components of the lid 100 work together to maintain uniform pressure distribution around the jar rim. The lid effectively militates against food or liquid from splashing out of the jar while the blender is operating.

When blending is complete, the user can pull up on the handle 102 to release the seal. The upward movement allows the spring element 150 to mechanically move the gasket support 108 from the expanded position back to the contracted position, smoothly disengaging the gasket 110 from the jar walls. The lid 100 can then be removed from the jar without the difficulty often associated with traditional twist-on blender lids that can become stuck due to pressure buildup within the jar during blending.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A lid for a container, comprising:
a handle;
a handle body, the handle hingedly coupled to the handle body and movable between a raised position and a lowered position;
a lid body including a top portion and a bottom portion, the top portion secured between the handle body and the bottom portion of the lid body, and the bottom portion of the lid body having a coupling section and a frustoconical section, the bottom portion being movable between a resting position and a lifted position, the handle body coupled to the coupling section of the bottom portion of the lid body;
a gasket support disposed between the top portion of the lid body and the bottom portion of the lid body, the gasket support disposed adjacent the frustoconical section of the bottom portion, the gasket support being movable along the frustoconical section between an expanded position and a contracted position by a movement of the handle; and
a gasket with an interior surface circumscribing and abutting the gasket support and disposed adjacent the top portion and the bottom portion of the lid body, the gasket being elastically deformable between a sealed position and an unsealed position by a movement of the gasket support,
wherein the gasket in the sealed position is sealingly engaged with the container, and the gasket in the unsealed position is disengaged from the container.

2. The lid of claim 1, wherein the handle body is centrally positioned adjacent to the top portion of the lid body.

3. The lid of claim 1, wherein the frustoconical section is defined by a plurality of sloped ribs arranged around the bottom portion of the lid body, the plurality of sloped ribs abutting the gasket support.

4. The lid of claim 1, wherein the bottom portion of the lid has a lip.

5. The lid of claim 4, wherein the lip of the bottom portion of the lid has a beveled surface that is oriented at a first angle.

6. The lid of claim 5, wherein the gasket includes a sloped surface that is oriented at a second angle, with the second angle substantially corresponding with the first angle of beveled surface of the lip on the bottom portion of the lid body.

7. The lid of claim 1, wherein the gasket support has a first diameter when in the contracted position and a second diameter when in the expanded position, and an interior surface of the top portion of the lid body has a third diameter, the first diameter being less than the second diameter, and the second diameter being less than the third diameter.

8. The lid of claim 1, wherein the top portion of the lid body has an annular depression that receives the handle when moved to the lowered position.

9. The lid of claim 1, wherein the gasket support has an annular recess, the gasket has an annular protrusion disposed on the interior surface of the gasket, and the annular recess of the gasket support receives the annular protrusion of the gasket.

10. The lid of claim 1, wherein the bottom portion of the lid body has an annular channel, the top portion of the lid body has an annular projection, and the annular channel of the bottom portion receives the annular projection of the top portion of the lid body.

11. The lid of claim 1, wherein the top portion of the lid body defines a first aperture through which the coupling section of the bottom portion of the lid body is disposed.

12. The lid of claim 11, wherein the handle body further defines a second aperture that is selectively closed or opened by a plug that is removably disposed in the second aperture.

13. The lid of claim 12, wherein the second aperture has a fourth diameter, and the plug has a fifth diameter, the fourth diameter being substantially the same as the fifth diameter so that the plug is securely held by friction fit with the handle body when the plug is removable imposed in the second aperture.

14. The lid of claim 1, wherein the gasket support includes a first brace, a second brace, and a spring element, the spring element coupling the first brace and the second brace.

15. The lid of claim 1, wherein the top portion of the lid body has a post disposed on an bottom side of the top portion, the gasket support has an opening, and the post of the lid body is disposed through the opening of the gasket support to couple the top portion of the lid body to the gasket support.

16. The lid of claim 1, wherein the lid body, the gasket support, and the gasket have a circular cross section configured for use with a container having a circular cross section.

17. The lid of claim 1, where the gasket is formed from an elastic material.

18. The lid of claim 1, wherein the container is a blender.

19. A container assembly, comprising:
a container; and
a lid having
a handle,
a handle body, the handle hingedly coupled to the handle body and movable between a raised position and a lowered position,
a lid body including a top portion and a bottom portion, the top portion secured between the handle body and the bottom portion of the lid body, and the bottom portion of the lid body having a coupling section and a frustoconical section, the bottom portion being movable between a resting position and a lifted position, the handle body coupled to the coupling section of the bottom portion of the lid body,
a gasket support disposed between the top portion and the bottom portion of the lid body, the gasket support disposed adjacent the frustoconical section of the bottom portion, the gasket support being movable along the frustoconical section between an expanded position and a contracted position by a movement of the handle, and
a gasket with an interior surface circumscribing and abutting the gasket support and disposed adjacent the top portion and the bottom portion of the lid body, the gasket being elastically deformable between a sealed position and an unsealed position by a movement of the gasket support,
wherein the gasket in the sealed position is sealingly engaged with the container, and the gasket in the unsealed position is disengaged from the container.

20. A method for holding contents, the method comprising steps of:
providing a container;
placing the contents in the container;
providing a lid having
a handle,
a handle body, the handle hingedly coupled to the handle body and movable between a raised position and a lowered position,
a lid body including a top portion and a bottom portion, the top portion secured between the handle body and the bottom portion of the lid body, and the bottom portion of the lid body having a coupling section and a frustoconical section, the bottom portion being movable between a resting position and a lifted position, the handle body coupled to the coupling section of the bottom portion of the lid body,
a gasket support disposed between the top portion and the bottom portion of the lid body, the gasket support disposed adjacent the frustoconical section of the bottom portion, the gasket support being movable along the frustoconical section between an expanded position and a contracted position by a movement of the handle, and
a gasket with an interior surface circumscribing and abutting the gasket support and disposed adjacent the top portion and the bottom portion of the lid body, the gasket being elastically deformable between a sealed position and an unsealed position by a movement of the gasket support,
wherein the gasket in the sealed position is sealingly engaged with the container, and the gasket in the unsealed position is disengaged from the container;
placing the lid onto the container; and
moving the handle from the raised position to the lowered position, whereby the bottom portion of the lid body is caused to move from the resting position and the lifted position, the gasket support is caused to move from the contracted position to the expanded position, and the gasket is caused to deform from the unsealed position to the sealed position to form a fluid-tight seal between the lid and the container, to thereby seal the contents within the container.
